(19) United States
(12) Patent Application Publication
(10) Pub. No.: US 2012/0316356 A1
(43) Pub. Date: Dec. 13, 2012

(54) METHOD FOR HYDROSILYLATION USING A PLATINUM CATALYST

(75) Inventors: Alfred Popp, Unterhacing (DE); Konrad Mautner, Burghausen (DE)

(73) Assignee: WACKER CHEMIE AG, Munich (DE)

(21) Appl. No.: 13/578,485

(22) PCT Filed: Feb. 1, 2011
(86) PCT No.: PCT/EP2011/051363

§ 371 Date: Aug. 10, 2012

(30) Foreign Application Priority Data
Feb. 11, 2010 (DE) 10 2010 001 836.8

(51) Int. Cl. C07F 7/14

(52) U.S. Cl. 556/479

(57) ABSTRACT

The selectivity of hydrosilylation of unsaturated organic compounds by Si—H functional organosilicon compounds is improved by use of a silyl polyphosphate ester in conjunction with a platinum hydrosilylation catalyst.

### CROSS-REFERENCE TO RELATED APPLICATION

This application is the U.S. national phase of PCT Appln. No. PCT/EP2011/051363 filed Feb. 1, 2011 which claims priority to German application DE 10 2010 001 836.8 filed Feb. 11, 2010, which are incorporated herein by reference.

### BACKGROUND OF THE INVENTION

1. Field of the Invention

The invention relates to a process for preparing organofunctional organosilicon compounds by reacting olefins with a compound containing SiH groups in the presence of a dissolved platinum catalyst and of at least one further additional component.

2. Description of the Related Art

Organofunctional silanes are of great economic interest and nowadays encompass many industrial fields of use.

3-Chloropropylchlorosilanes, in particular, are important intermediates in the preparation of organofunctional silanes. They are generally prepared by hydrosilylation of allyl chloride. 3-Chloropropyltrichlorosilane and 3-chloropropylmethyl-dichlorosilane can be used to prepare, for example, 3-chloropropyltrialkoxysilanes, 3-chloropropylmethyl-dialkoxysilanes, 3-aminopropyltrialkoxysilanes, 3-aminopropylmethyldialkoxysilanes, N-aminoethyl-3-aminopropyltrialkoxysilanes, N-aminoethyl-3-aminopropylmethyldialkoxysilanes, 3-cyanopropyl-alkoxysilanes, 3-glycidyloxypropylalkoxysilanes, and 3-methylacryloxypropylalkoxysilanes, to name only a few examples.

The addition of Si-bonded hydrogen onto aliphatic multiple bonds has been known for a long time and is referred to as hydrosilylation. This reaction is promoted, for example, by homogeneous and heterogeneous platinum catalysts.

Metal complex catalysts are frequently added as cocatalysts to a homogeneous catalyst system to increase selectivity and reactivity.

JP3122358 describes hydrosilylation in the presence of phosphines as cocatalysts.

EP 1 266 903 claims the use of, for example, silyl esters of oxo & sulfur acids, Si—N-substituted amides, urea compounds, silyl carbamates and ortho-phosphoric acid compounds for enhancing selectivity.

Experiments show that, for example, the hydrosilylation of allyl chloride (R¹═H, n=1, X═Cl) with methyldichlorosilane (Y═Cl, b=2, R²═CH₃, a=1) at a molar ratio of 1:1 for the reactants and the use of a catalyst gives a maximum 3-chloropropylmethyldichloro-silane yield of 49 mol % (see comparative example A in DE 10243180 A1), since two undesired by-products are formed:

methyltrichlorosilane (NP1 with R¹═H, n=1) and dichloromethylpropylsilane (NP2 with Y═Cl, b=2, R²═CH₃, a=1, n=1, R¹═H). The latter is very difficult to use in an economically sensible manner.

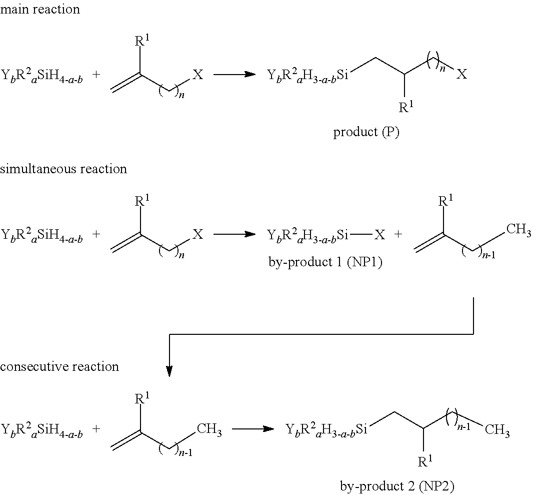

An improvement to the process mentioned is described in EP 1 266 903 B1. Monomeric derivatives of ortho-phosphoric acid such as, for example, trialkyl or trisalkoxy phosphates are used therein inter alia as cocatalysts. However, undesired side reactions nonetheless take place to an unacceptable degree, nor are the cocatalysts simple to remove.

### SUMMARY OF THE INVENTION

The present invention provides a process for adding a silicon compound S, which contains at least one SiH group, onto a compound A, which contains at least one aliphatic C═C double bond, in the presence of a platinum catalyst and of a silyl polyphosphate ester. The inventors have surprisingly discovered that the addition of silyl polyphosphate esters to a platinum catalyst system as opposed to the above-mentioned monomeric ortho-phosphoric acid derivatives, appreciably reduces the number of unwanted side-reactions in the preparation of organofunctional organosilicon compounds. It is a further advantage that the silyl polyphosphate ester has a distinctly higher boiling point than the monomeric derivatives, and hence the catalyst system, which comprises platinum catalyst and silyl polyphosphate ester, is simpler to remove from the product, for example by distillation.

### DETAILED DESCRIPTION OF THE PREFERRED EMBODIMENTS

The preparation and composition the silyl polyphosphate esters which is extensively described in the literature (for example Yamamoto et al., CHEM. LETT, 1982, p. 1225-1228; and Imamoto et al., J. ORG. CHEM., 1984, p. 1105-1110). Using these silyl polyphosphate esters as cocatalysts makes it possible for example to distinctly reduce the formation of propene from allyl chloride, which reduces the yield through the subsequent reaction of the propene with methyldichlorosilane for example to form the unwanted propylmethyldichlorosilane. It is specifically the surprisingly advantageous effect of combining a platinum catalyst that makes it possible to render the process simpler and more economical. In addition, the formation of the low economical value by-products, such as dichloromethylpropylsilane can be suppressed.

The process for preparing organofunctional organosilicon compounds in accordance with the present invention preferably utilizes for the reaction a compound A of general formula I

X—(CH₂)ₙ—C(R¹)═CH₂

where
X is hydrogen, chlorine, bromine, —CN, fluoroalkyl of formula CₘF₂ₘ₊₁, alkoxypropyl ether of formula RO—(CH₂—CHR—O)_{y}—, 2,3-epoxy-1-propyl or CH₂═CR—COO—,
R and R¹ are each a hydrogen atom or a linear or branched C₁-C₄ alkyl moiety,
Y is 0 or an integer from 1 to 30,
m is an integer from 1 to 20, and
n is 1, 2 or 3.

Preferred alkyl moieites R and R¹ are methyl, ethyl, n-propyl and isopropyl. Preferred values of y and m are 0, 1, 2, 3, 4, 5 and 6.

It is particularly preferable to use 3-chloro-1-propene, also known as allyl chloride, or 3-chloro-2-methyl-1-propene, also called methallyl chloride, as unsaturated compound A.

The process of the present invention preferably utilizes, as an HSi-containing compound S a hydrogen silane of general formula II

H_{4-a-b}SiR²ₐY_{b} (II),

where
R² is a linear, branched or cyclic alkyl moiety of 1 to 16 carbon atoms or an aryl moiety of 6 to 30 carbon atoms,
Y is chlorine, bromine, methoxy or ethoxy, and
a and b are each 0, 1, 2 or 3 subject to the condition that 1≦(a+b)≦3.

Preferred alkyl R² moieties have from 1 to 10 and especially from 1 to 6 carbon atoms. Particularly preferred alkyl R² are methyl, ethyl, n-propyl, isopropyl, n-butyl, isobutyl, sec-butyl or tert-butyl.

Examples of aryl R² moieties are unsubstituted and alkyl-substituted aryl moieties such as phenyl, naphthyl, o-, m-, p-tolyl, xylyl, ethylphenyl, benzyl, α-phenylethyl and β-phenylethyl. Preferred aryl moieties have from 6 to 14 carbon atoms.

The HSi-containing compound is more preferably trichlorosilane, methyldichloro-silane or dimethylchlorosilane.

The process is used to prepare 3 chloropropylchlorosilanes in particular.

Preferably, a mole of SiH groups in silicon compound S is reacted with at least 1 mol, more preferably at least 2 mol and especially at least 3 mol, and at most 20 mol, more preferably at most 10 mol and especially at most 5 mol of aliphatic C═C double bonds in compound A.

The platinum content of the platinum catalyst is preferably at least 0.01 wt %, more preferably at least 0.1 wt % and especially at least 0.5 wt % and at most 20 wt %, more preferably at most 10 wt % and especially at most 5 wt %.

The platinum-olefin complexes of the formulae (PtCl₂.olefin)₂ and H(PtCl₃.olefin) for example can be used as platinum catalyst, in which case olefins with 2 to 16 carbon atoms, such as ethylene, propylene, isomers of butene and of octene, 1-dodecene, 6-dodecene or cycloalkenes with 5 to 7 carbon atoms, such as cyclopentene, cyclohexene and cycloheptene, are preferred. Further platinum catalysts are the platinum-cyclopropane complex of the formula (PtCl₂.C₃H₆)₂, the reaction products of hexachloroplatinic acid with alcohols, ethers and aldehydes/mixtures thereof, or the reaction product of hexachloroplatinic acid with methylvinylcyclotetrasiloxane in the presence of sodium bicarbonate in ethanolic solution, finely divided platinum on carrier materials such as silica, alumina or activated wood/animal charcoal, platinum halides such as PtCl₄, hexachloroplatinic acid and Na₂PtCl₄.nH₂O, platinum-olefin complexes, for example those with ethylene, propylene or butadiene, platinum-alcohol complexes, platinum-styrene complexes as described in U.S. 4 394 317, platinum-alkoxide complexes, platinum acetylacetonates, reaction products of chloroplatinic acid and monoketones, for example cyclohexanone, methyl ethyl ketone, acetone, methyl n-propyl ketone, diisobutyl ketone, acetophenone and mesityl oxide, as well as platinum-vinylsiloxane complexes, especially the platinum-vinylsiloxane complexes described in U.S. Pat. Nos. 3,715,334, 3,775,452 and 3,814,730, such as platinum-divinyltetramethyldisiloxane complexes.

The process of the present invention utilizes with particular preference a KARSTEDT catalyst, i.e., a Pt(0) complex, especially the platinum(0)-divinyltetramethyldisiloxane complex of formula Pt₂—[[(CH₂═CH)(CH₂)₂Si]₂O]₂. It is likewise preferable to use a platinum-olefin complex, especially the platinum-(1-dodecene) complex. The platinum catalyst is suitably used as solute in a substantially inert aromatic, aliphatic or olefinic hydrocarbon, preferably xylene or toluene, in a ketone, preferably acetone, methyl ethyl ketone or cyclohexanone, or in an alcohol, preferably methanol, ethanol, n-propanol or i-propanol. Particular preference is given to the solution in the complex-forming ligand, such as dodecene for example. The Pt content of the solution is preferably at least 0.1 wt %, more preferably at least 0.5 wt %, and at most 10 wt %, more preferably at most 5 wt %.

A mole of Pt in the platinum catalyst preferably utilizes at least 1000 mol, more preferably at least 10,000 mol and especially at least 15,000 mol and at most 70,000 mol, more preferably at most 60,000 mol and especially at most 40,000 mol of aliphatic C═C double bond in compound A.

Preferred silyl polyphosphate esters have the general formulae III, IV and V

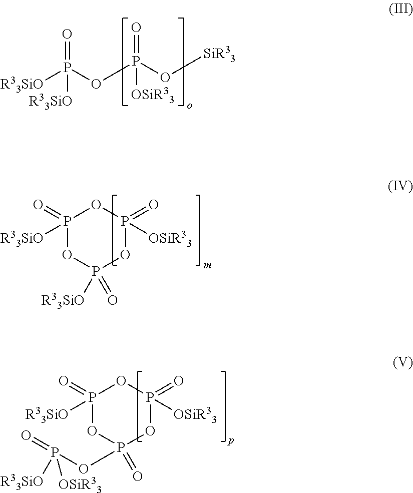

where
R³ is a linear, branched or cyclic alkyl moiety of 1 to 16 carbon atoms or an aryl moiety of 6 to 30 carbon atoms,
o is an integer from 1 to 10, and
m and p are each an integer from 1 to 5.

One silyl polyphosphate ester or a mixture of two or more thereof can be used.

Examples of preferred alkyl R³ moieties and aryl R³ moieties correspond to the examples of preferred alkyl R² and aryl R² moieties.

Preferred values of o are 1, 2, 3, 4, 5 and 6.

Preferred values of m and p are 1, 2, 3 and 4.

The process of the present invention is preferably carried out using as a silyl polyphosphate ester, the trimethylsilyl polyphosphate ester (PPSE) wherein R³ is CH₃, and which constitutes a mixture of components of general formulae (III) where o=1 and 2, (IV) where m=1 and (V) where p=1.

The process of the present invention is carried out, for example, by adding the silyl polyphosphate ester to the platinum catalyst solution and then adding the resultant catalyst solution to a mixture of at least one HSi-containing compound S and at least one compound A containing an aliphatic C═C double bond. It is also possible, however, to initially charge one of the two educt components or a mixture thereof and add the platinum catalyst as a solute in a solvent, followed by adding the silyl polyphosphate ester in a suitable manner with thorough commixing. It is further possible to initially charge one of the two educt components or a mixture thereof, add the silyl polyphosphate ester and subsequently introduce the platinum catalyst solution into the reaction mixture. It is likewise possible to meter one of the educt components, preferably the HSi-containing compound S.

One part by weight of Pt in the platinum catalyst preferably is used in conjunction with at least 0.001 part by weight, more preferably at least 0.1 part by weight, and especially at least 1 part by weight and at most 1000 parts by weight, more preferably at most 500 parts by weight and especially at most 100 parts by weight of silyl polyphosphate ester.

One mole of Pt in the platinum catalyst is preferably used to catalyze the reaction of at least 50 mol, more preferably at least 102 mol and especially at least 103 mol, and at most 1010 mol, more preferably at most 500 mol and especially at most 108 mol, of SiH groups in compound S.

The process of the present invention is preferably carried out at a temperature of at least 10° C., more preferably at least 20° C. and especially at least 30° C., and at most 200° C., more preferably at most 180° C. and especially at most 150° C.

The process of the present invention is preferably carried out at a pressure of at least 0.5 bar absolute, more preferably at least 1 bar absolute and at most 50 bar absolute, more preferably at most 10 bar absolute and especially at the pressure of the ambient atmosphere.

The process of the present invention can provide for example functional organosilanes, especially 3-chloropropyltrichlorosilane, 3-chloropropyltrialkoxy-silanes, 3-chloropropylmethyldichlorosilane and also 3-chloropropylmethyldialkoxysilanes, where alkoxy is preferably methoxy or ethoxy.

The process of the present invention is preferably carried out by reacting 3-chloro-1-propene with a hydrogen chlorosilane of general formula II, especially with trichlorosilane or methyldichlorosilane, in the presence of a platinum catalyst and by adding at least one silyl polyphosphate ester, preferably by using the catalyst and the silyl polyphosphate ester conjointly in a solvent, the hydrosilylation product being recovered from the reaction mixture. Preferably, the hydrosilylation product is esterified with an alcohol in a conventional manner to obtain a 3-chloropropylalkoxysilane. Methanol, ethanol or 2-methoxyethanol is preferably used as alcohol to esterify the hydrosilylation product.

The use of a solvent is preferred, and aprotic organic solvents are most preferred. Solvents or solvent mixtures having a boiling point/range of up to 120° C. at 1 bar absolute are preferred. Examples of such solvents are ethers such as dioxane, tetrahydrofuran, diethyl ether, diisopropyl ether, and diethylene glycol dimethyl ether; chlorinated hydrocarbon such as dichloromethane, trichloromethane, tetrachloromethane, 1,2-dichloroethane, and trichloroethylene; hydrocarbon such as pentane, n-hexane, hexane isomer mixtures, heptane, octane, solvent naphtha, petroleum ether, benzene, toluene, and xylene(s); alkylchlorosilanes and siloxanes, especially linear dimethylpolysiloxanes having trimethylsilyl end groups with preferably from 0 to 6 dimethylsiloxane units, or cyclic dimethylpolysiloxanes with preferably from 4 to 7 dimethylsiloxane units, for example hexamethyldisiloxane, octamethyltrisiloxane, octamethylcyclotetrasiloxane and decamethylcyclopenta-siloxane; ketones such as acetone, methyl ethyl ketone, diisopropyl ketone, and methyl isobutyl ketone (MIBK); ester such as ethyl acetate, butyl acetate, propyl propionate, ethyl butyrate, and ethyl isobutyrate; carbon disulfide; nitrobenzene, and mixtures thereof.

In a preferred embodiment, the hydrosilylation product is used as solvent and, more preferably, is initially charged.

In a preferred embodiment, the process of the present invention is carried out as follows:

For example, compound A, which contains aliphatic C═C double bonds, an example of which is allyl chloride, can be initially charged to a reaction vessel. Then, the HSi-containing compound S, for example methyldichlorosilane, is added to compound A and the reaction vessel contents are thoroughly commixed. This is followed by the addition of the platinum catalyst system which was suitably prepared separately by mixing the platinum complex with the silyl polyphosphate ester, e.g., trimethylsilyl polyphosphate ester (PPSE).

The reaction mixture admixed with catalyst can then be slowly heated until the boiling point of the mixture is reached and reflux ensues. The boiling temperature is determined by the type of reaction components (educts).

The ensuing hydrosilylation reaction is generally noticeable by an increased pot temperature of the reaction vessel, since the addition reaction gives rise to products that have significantly higher boiling points than the starting materials. Conversion of educts is generally tracked by periodic sampling and GC determination of the ingredients. As soon as no significant increase in the content of the desired reaction product in the reaction mixture is detectable, the distillative removal of low boilers from the reaction mixture can be commenced, if necessary under reduced pressure. This can be followed by a final distillation of the product, which is frequently again carried out under reduced pressure. It will be found advantageous, in this respect, that the silyl polyphosphate ester remains in the high-boiling bottom product together with the platinum catalyst.

The outstanding efficacy of the catalyst system used according to the present invention generally ensures that the addition of HSi-containing compound S onto compound A, which contains aliphatic C═C double bonds, will take place so rapidly that side reactions are substantially suppressed and the yield and the purity of desired product is distinctly higher than when using a prior art catalyst.

The process of the present invention provides, for example, 3-chloropropylmethyldichlorosilane in outstanding yield, in a manner which is advantageous because it is simple and economical.

The process can be run as a batch operation or as a continuous operation, in which case continuous operation is preferred.

All the above symbols in the above formulae each have their meanings independently of each other. The silicon atom is tetravalent in all formulae.

In the examples which follow, all amounts and percentages are by weight, all pressures are 0.10 MPa (abs.) and all temperatures 20° C., unless otherwise stated. Reported selectivities relate to the reactions set forth hereinbelow:

Main reaction, formation of 3-chloropropylmethyldichlorosilane (P)

HSiCl₂(CH₃)+H₂C═CH—CH₂—Cl→[SiCl₂(CH₃)]—CH₂—CH₂—CH₂—Cl (1)

Side reaction 1, formation of by-product 1 (NP1)

HSiCl₂(CH₃)+H₂C═CH—CH₂—Cl→H₂C═CH—CH₃+SiCl₃(CH₃) (2)

Side reaction 2, formation of by-product 2 (NP2)

H₂C═CH—CH₃+HSiCl₂(CH₃)→[SiCl₂(CH₃)]—CH₂—CH₂—CH₃ (3)

Selectivity 1: molar ratio of by-product 1 to by-product 2 (NP1:NP2)
Selectivity 2: molar ratio of product to by-product 2 (P:NP2)

### Inventive Example 1

A 100 mL four-necked flask equipped with a thermometer, a reflux condenser (cooled to −30° C.), a 50 mL addition vessel (with water cooling) and a 5 mL addition vessel, is charged under nitrogen with 18.9 g of 3-chloropropylmethyldichlorosilane as solvent and 0.04 g of trimethylsilyl polyphosphate ester is dissolved therein. The solution is preheated to 90° C. using a magnetic stirrer and a heating mantle. A solution of 24.4 g of allyl chloride in 33.8 g of dichloromethylsilane and a solution of 0.08 g of platinum catalyst (Pt content 4.8%) in 5 g of allyl chloride are cocurrently added at this temperature over the course of 2 hours. On completion of the metered addition, the mixture is further stirred at 90° C. for 1 hour and then cooled down to room temperature. For safety reasons and to prevent any undesired secondary reaction, the reaction mixture is deactivated with 3 mL of a 10% solution of triphenylphosphine in toluene. The composition is evaluated by gas chromatography. To compute the conversions and selectivities, the 3-chloropropylmethyldichlorosilane initially charged as solvent is taken into account and arithmetically removed.

Inventive examples 1 to 6 and the non-inventive comparative example similar to EP 1266903 B1 are carried out under identical reaction conditions. The results are shown in table 1:

| | Auxil- | Conc. of | Conversion | Selec- | Selec- |
|---|---|---|---|---|---|
| | iary | auxiliary | [%] based | tivity 1 | tivity 2 |
| | catalyst | catalyst³ [ppm] | on compound S | NP1:NP2 | P:NP2 |
| Comp. | TEP¹ | 5560 | 99% | 5:1 | 33:1 |
| Ex. 1⁴ | | | | | |
| Ex. 1 | PPSE² | 243 | 99% | 13:1 | 51:1 |
| Ex. 2 | PPSE | 485 | 99% | 10:1 | 46:1 |
| Ex. 3 | PPSE | 2425 | 99% | 9:1 | 45:1 |
| Ex. 4 | PPSE | 4850 | 99% | 9:1 | 48:1 |
| Ex. 5 | PPSE | 9700 | 99% | 13:1 | 79:1 |
| Ex. 6 | PPSE | 14550 | 99% | 18:1 | 114:1 |

¹TEP = triethyl phosphate
²PPSE = trimethylsilyl polyphosphate ester
³based on final mass of reaction
⁴non-inventive comparative example

The data in the table evidence that the inventive use of silyl polyphosphate ester is able to distinctly improve the selectivities, while the conversion based on the H-silane is unchanged.

1.-8. (canceled)

9. A process for the hydrosilylative addition of a silicon compound S which contains at least one SiH group, onto a compound A which contains at least one aliphatic C═C double bond, comprising hydrosilylating in the presence of a platinum catalyst and a silyl polyphosphate ester.

10. The process as claimed in claim 1 wherein said compound A is of the formula I
X—(CH₂)ₙ—C(R¹)═CH₂ (I),
where
X is hydrogen, chlorine, bromine, —CN, fluoroalkyl of the formula CₘF₂ₘ₊₁, alkoxypropyl ether of the formula RO—(CH₂—CHR—O)_{y}—, 2,3-epoxy-1-propyl or CH₂═CR—COO—,
R and R¹ are each hydrogen or a linear or branched C₁-C₄ alkyl moiety,
y is 0 or an integer from 1 to 30,
m is an integer from 1 to 20, and
n is 1, 2 or 3.

11. The process of claim 9, wherein the compound S is a hydrogen silane of formula II
H_{4-a-b}SiR²ₐY_{b} (II),
where
R² is a linear, branched or cyclic alkyl moiety of 1 to 16 carbon atoms or an aryl moiety of 6 to 30 carbon atoms,
Y is chlorine, bromine, methoxy or ethoxy, and
a and b are each 0, 1, 2 or 3 subject to the condition that 1≦(a+b)≦3.

12. The process of claim 10, wherein the compound S is a hydrogen silane of formula II
H_{4-a-b}SiR²ₐY_{b} (II),
where
R² is a linear, branched or cyclic alkyl moiety of 1 to 16 carbon atoms or an aryl moiety of 6 to 30 carbon atoms,
Y is chlorine, bromine, methoxy or ethoxy, and
a and b are each 0, 1, 2 or 3 subject to the condition that 1≦(a+b)≦3.

13. The process of claim 9, wherein a platinum catalyst is a platinum-divinyltetramethyldisiloxane complex of the formula Pt₂[[(CH₂═CH)(CH₃)₂Si]₂O]₃.

14. The process of claim 10, wherein a platinum catalyst is a platinum-divinyltetramethyldisiloxane complex of the formula Pt₂[[(CH₂═CH)(CH₃)₂Si]₂O]₃.

15. The process of claim 9, wherein a platinum catalyst is a platinum-(1-dodecene) complex.

16. The process of claim 10, wherein a platinum catalyst is a platinum-(1-dodecene) complex.

17. The process of claim 9, wherein at least one silyl polyphosphate ester has a formula selected from the group consisting of formulae III, IV and V 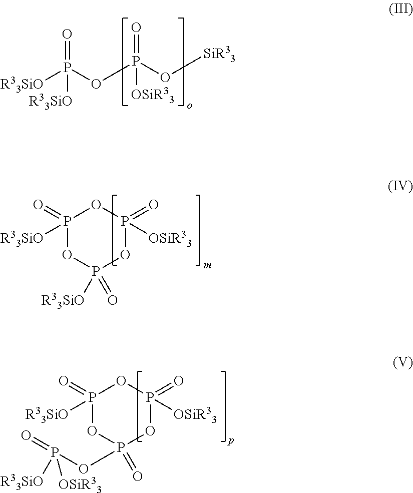
where
R³ is a linear, branched or cyclic alkyl moiety of 1 to 16 carbon atoms or an aryl moiety of 6 to 30 carbon atoms,
o is an integer from 1 to 10, and
m and p are each an integer from 1 to 5.

18. The process of claim 10, wherein at least one silyl polyphosphate ester has a formula selected from the group consisting of formulae III, IV and V 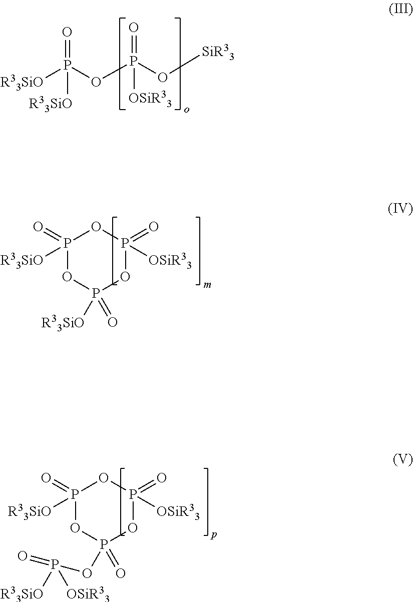
where
R³ is a linear, branched or cyclic alkyl moiety of 1 to 16 carbon atoms or an aryl moiety of 6 to 30 carbon atoms,
o is an integer from 1 to 10, and
m and p are each an integer from 1 to 5.

19. The process of claim 11, wherein at least one silyl polyphosphate ester has a formula selected from the group consisting of formulae III, IV and V 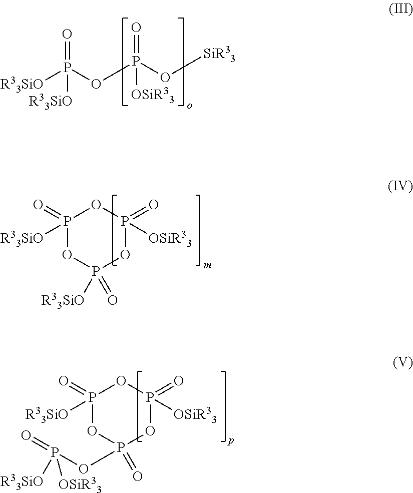
where
R³ is a linear, branched or cyclic alkyl moiety of 1 to 16 carbon atoms or an aryl moiety of 6 to 30 carbon atoms,
o is an integer from 1 to 10, and
m and p are each an integer from 1 to 5.

20. The process of claim 13, wherein at least one silyl polyphosphate ester has a formula selected from the group consisting of formulae III, IV and V 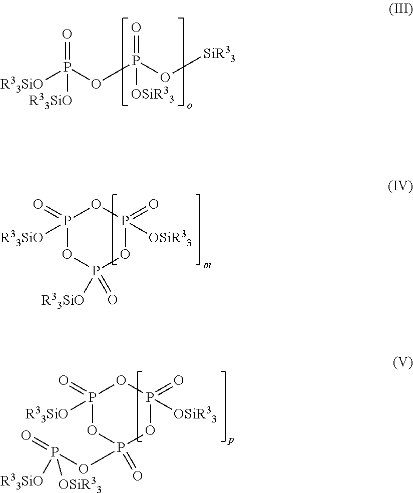
where
R³ is a linear, branched or cyclic alkyl moiety of 1 to 16 carbon atoms or an aryl moiety of 6 to 30 carbon atoms,
o is an integer from 1 to 10, and
m and p are each an integer from 1 to 5.

21. The process of claim 14, wherein at least one silyl polyphosphate ester has a formula selected from the group consisting of formulae III, IV and V 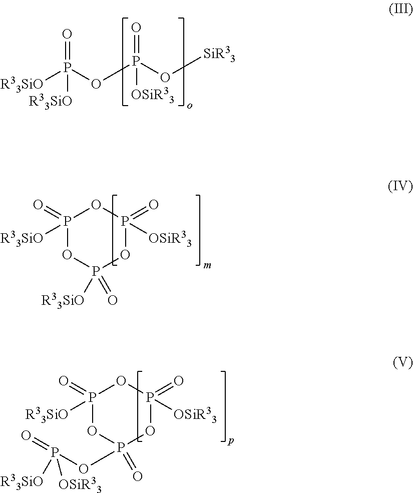
where
R³ is a linear, branched or cyclic alkyl moiety of 1 to 16 carbon atoms or an aryl moiety of 6 to 30 carbon atoms,
o is an integer from 1 to 10, and
m and p are each an integer from 1 to 5.

22. The process of claim 9, wherein 3-chloropropylchlorosilanes are prepared as a product of hydrosilylation.

23. The process of claim 9, wherein from 0.1 to 100 parts by weight of silyl polyphosphate ester are used per one part by weight of Pt in the platinum catalyst.
